(19) United States
(12) Patent Application Publication
(10) Pub. No.: US 2023/0070748 A1
(43) Pub. Date: Mar. 9, 2023

(54) POLYMER COMPOSITION

(71) Applicant: BOREALIS AG, Vienna (AT)

(72) Inventors: Thomas GKOURMPIS, Stenungsund (SE); Per-Ola HAGSTRAND, Stenungsund (SE); Nilsson FRITJOF, Stockholm (SE); Ulf GEDDE, Huddinge (SE); Mikael HEDENQVIST, Nacka (SE); Richard OLSSON, Lidingö (SE); Mattias KARLSSON, Västerås (SE); Christian MÜLLER, Göteborg (SE); Roland KÁDÁR, Hovås (SE); Karolina GASKA, Bristol Avon (GB)

(21) Appl. No.: 17/796,339

(22) PCT Filed: Jan. 29, 2021
(86) PCT No.: PCT/EP2021/052212

§ 371 Date: Jul. 29, 2022

(30) Foreign Application Priority Data
Jan. 30, 2020 (EP) 20154743.7

(51) Int. Cl. C08L 23/06; C08K 9/06; H01B 3/44; H01B 9/00

(52) U.S. Cl. CPC C08L 23/06; C08K 9/06; H01B 3/441; H01B 9/006; C08K 2201/011; C08L 2203/202; C08L 2205/025; C08L 2207/062; C08L 2207/066

(57) ABSTRACT

A polymer composition comprising (i) at least 70 wt% of low-density polyethylene (LDPE) homopolymer or copolymer having a density of 905 to 935 kg/m³ (ISO 1183-2) and an MFR₂ of 0.1 to 10 g/10 min (ISO1133 at 190° C., 2.16 kg); (ii) 0.5 to 20 wt % of a high density polyethylene (HDPE) having a density of 940 kg/m³ or more and an MFR₂ of 0.1 to 50 g/10 min; and (iii) 0.05 to 10 wt% of an aliphatic, preferably alkyl, functional inorganic nanoparticle filler.

The present invention relates to a polymer composition with advantageously low direct current (DC) electrical conductivity. In particular, the invention relates to a polymer composition comprising a blend of low-density polyethylene (LDPE), high density polyethylene (HDPE) and an aliphatic functional inorganic nanoparticle filler, as well as the use of this composition in the manufacture of cables, especially in the manufacture of the insulation layer of a power cable.

### BACKGROUND

Polyolefins produced in a high-pressure (HP) process are widely used in demanding polymer applications wherein the polymers must meet high mechanical and/or electrical requirements. For instance in power cable applications, particularly in medium voltage (MV) and especially in high voltage (HV) and ultra-high voltage (UHV) cable applications the electrical properties of the polymer composition has a significant importance. Furthermore, the electrical properties of importance may differ in different cable applications, as is the case between alternating current (AC) and direct current (DC) cable applications.

A typical power cable comprises a conductor surrounded, at least, by an inner semiconductive layer, an insulation layer and an outer semiconductive layer. The cables are commonly produced by extruding the layers on a conductor. The polymer material in one or more of said layers is then often crosslinked.

The DC electrical conductivity is an important material property e.g. for the insulating materials in high voltage direct current (HVDC) cables. Firstly, the strong temperature and electric field dependence of this property will influence the electric field. The second issue concerns the heat generated inside the insulation by the electric leakage current flowing between the inner and outer semiconductive layers. This leakage current depends on the electric field and the electrical conductivity of the insulation. High conductivity of the insulating material may lead to a thermal runaway under high stress/high temperature conditions. The electrical conductivity must therefore be sufficiently low to avoid thermal runaway.

Accordingly, in HVDC cables, the insulation is partly heated by the leakage current. For a specific cable design the heating is proportional to the insulation conductivity × voltage². Thus, if the voltage is increased more heat will be generated, unless the electrical conductivity is decreased by a higher factor than the square of the factorial increase of the applied voltage.

There are high demands to increase the voltage of a direct current (DC) power cable, and thus a continuous need to find alternative polymer compositions with reduced DC conductivity. Such polymer compositions should also have sufficiently good mechanical properties required for demanding power cable applications.

WO2017/149086 & WO2017/149087 relate to the use of nanoparticle fillers in polymer compositions. However, the use of said fillers in blends of LDPE and HDPE is not disclosed, and the conductivity of the exemplified compositions is still relatively high.

EP3261095 relates to a cable comprising a polymer composition comprising a blend of LDPE and HDPE. The use of nanoparticle fillers is however not disclosed, and the conductivity of the exemplified compositions is still relatively high.

There remains a need therefore for new polymer compositions having further reduced DC conductivity. The present inventors have now established that a polymer composition comprising a blend of LDPE, HDPE and an aliphatic functional inorganic nanoparticle filler has surprisingly low DC conductivity, thereby being particularly suitable for use in the manufacture of high voltage power cables. It is believed that the claimed combination of components gives rise to a synergistic combination which offers exceptionally low DC conductivity. Furthermore, the polymer compositions of the present invention have maintained, or even improved, thermomechanical properties.

### SUMMARY OF THE INVENTION

Thus, in one aspect the invention provides a polymer composition comprising:
(i) at least 70 wt% of low-density polyethylene (LDPE) homopolymer or copolymer having a density of 905 to 935 kg/m³ and an MFR₂ of 0.1 to 10 g/10 min;
(ii) 0.5 to 20 wt% of a high density polyethylene (HDPE) having a density of 940 kg/m³ or more and an MFR₂ of 0.1 to 50 g/10 min; and
(iii) 0.05 to 10 wt% of an aliphatic, preferably alkyl, functional inorganic nanoparticle filler.

Viewed from another aspect, the invention provides a process for the preparation of a polymer composition as hereinbefore defined, comprising blending:
(i) at least 70 wt% of low-density polyethylene (LDPE) homopolymer or copolymer having a density of 905 to 935 kg/m³ and an MFR₂ of 0.1 to 10 g/10 min;
(ii) 0.5 to 20 wt% of a high density polyethylene (HDPE) having a density of 940 kg/m³ or more and an MFR₂ of 0.1 to 50 g/10 min; and
(iii) 0.05 to 10 wt% of an aliphatic, preferably alkyl, functional inorganic nanoparticle filler.

Viewed from a further aspect, the invention provides a cable comprising a conductor surrounded by one or more layers wherein one or more of said layers comprises a polymer composition as hereinbefore defined. In a still further aspect, the invention provides a power cable, for example a direct current (DC) power cable, comprising a conductor which is surrounded at least by an inner semiconductive layer, an insulation layer and an outer semiconductive layer, in that order, wherein at least one layer, for example at least the insulation layer, comprises a polymer composition as hereinbefore defined.

Viewed from a still further aspect, the invention provides the use of a polymer composition as hereinbefore defined in the manufacture of a layer in a cable such as the insulation layer of a power cable.

### DETAILED DESCRIPTION OF THE INVENTION

The present invention relates to a polymer composition comprising:
(i) at least 70 wt% of low-density polyethylene (LDPE) homopolymer or copolymer having a density of 905 to 935 kg/m³ and an MFR₂ of 0.1 to 10 g/10 min;
(ii) 0.5 to 20 wt% of a high density polyethylene (HDPE) having a density of 940 kg/m³ or more and an MFR₂ of 0.1 to 50 g/10 min; and
(iii) 0.05 to 10 wt% of an aliphatic, preferably alkyl, functional inorganic nanoparticle filler.

The amount of components (i) to (iii) in the composition may be varied independently. In one embodiment, the polymer composition comprises at least 75 wt% component (i), 0.5 to 15 wt% component (ii), and 0.1 to 10 wt% component (iii). In one embodiment, the polymer composition comprises at least 90 wt% component (i), 1.0 to 8.0 wt% component (ii), and 1.0 to 8.0 wt% component (iii).

In one embodiment the polymer composition consists of components (i) to (iii), so that the total amount of components (i) to (iii) equals 100%. In other embodiments, the polymer composition may comprise optional further components.

The present inventors have established that the polymer composition as described herein has surprisingly low DC conductivity. In one embodiment, the polymer composition has a DC conductivity of less than 4.0 x10⁻¹⁷ S/m when measured at 70° C.; and/or less than 2.5 x10⁻¹⁷ S/m when measured at 60° C.; and/or less than 3.5 x10⁻¹⁶ S/m when measured at 90° C. The DC conductivity is measured according to the “DC-conductivity measurement” as described under “Determination methods”. The lower limit for the DC-conductivity may be 4.0 x10⁻¹⁹ S/m when measured at 70° C.; and/or less than 2.5 x10⁻¹⁹ S/m when measured at 60° C.; and/or less than 3.5 x10⁻¹⁹ S/m when measured at 90° C.

The polymer composition may optionally be crosslinked. In a preferred embodiment, the polymer composition is not crosslinked. A “non-crosslinked” polymer composition means that the polymer composition in its final form e.g. in a layer of a cable, is not crosslinked and is hence thermoplastic.

Preferably, the polymer composition has a storage modulus (G′) determined according to the method described under “Determination Methods” of at least 1.0x10⁵ Pa at 115° C., more preferably at least 5.0x10⁵ Pa at 115° C.

In a preferred embodiment, the polymer composition has a storage modulus (G′) determined according to the method described under “Determination Methods” of at least 5.0x10⁴ Pa at 120° C., more preferably at least 1.0x10⁵ Pa at 120° C.

In a preferred embodiment the polymer composition has a storage modulus (G′) determined according to the method described under “Determination Methods” of at least 3.0x10⁴ Pa at 125° C., more preferably at least 5.0x10⁴ Pa at 125° C. Typically the polymer composition has a storage modulus G′) determined according to the method described under “Determination Methods” of up to 1.0x10⁷ Pa over the range 105 to 125° C.

### Component (i) - Low-Density Polyethylene (LDPE)

Component (i) of the polymer composition according to the present invention is a low-density polyethylene (LDPE). The LDPE forms at least 70% by weight of the overall polymer composition according to the present invention. In a preferred embodiment, the LDPE forms at least 75 wt% of the polymer composition, more preferably at least 90 wt%. The upper limit for LDPE may be 98 wt%.

The low density polyethylene, LDPE, is a polyethylene produced in a high pressure process. Typically the polymerization of ethylene and optional further comonomer(s) in the high pressure process is carried out in the presence of an initiator(s). The meaning of LDPE polymer is well known and documented in the literature.

Although the term LDPE is an abbreviation for low density polyethylene, the term is understood not to limit the density range, but covers the LDPE-like high pressure (HP) polyethylenes with low, medium and higher densities. The term LDPE describes and distinguishes a high pressure polyethylene from low pressure polyethylenes produced in the presence of an olefin polymerisation catalyst. LDPEs have certain typical features, such as different branching architecture and are inherently free from catalyst residues.

The LDPE according to the present invention may be crosslinked or non-crosslinked. A “non-crosslinked” low density polyethylene (LDPE) means that the LDPE present in a layer of a final DC cable (in use) is not crosslinked and is thus thermoplastic.

The LDPE according to the present invention is a low density homopolymer of ethylene (referred herein as LDPE homopolymer) or a low density copolymer of ethylene with one or more comonomer(s) (referred herein as LDPE copolymer). In one embodiment, said LDPE homopolymer or LDPE copolymer is optionally unsaturated. In one embodiment, the one or more comonomers of the LDPE copolymer is selected from the group consisting of polar comonomer(s), non-polar comonomer(s) or from a mixture of the polar comonomer(s) and non-polar comonomer(s).

In one embodiment, the LDPE is an unsaturated LDPE copolymer of ethylene. In a preferred embodiment, the LDPE is an unsaturated LDPE copolymer of ethylene with at least one polyunsaturated comonomer and optionally with one or more other comonomer(s). In one embodiment, the polyunsaturated comonomers consist of a straight carbon chain with at least 8 carbon atoms and at least 4 carbons between the non-conjugated double bonds, of which at least one is terminal. In a preferred embodiment, said polyunsaturated comonomer is a diene, preferably a diene which comprises at least eight carbon atoms, the first carbon-carbon double bond being terminal and the second carbon-carbon double bond being non-conjugated to the first one. Preferred dienes are selected from C₈ to C₁₄ non-conjugated dienes or mixtures thereof, more preferably selected from 1,7-octadiene, 1,9-decadiene, 1,11-dodecadiene, 1,13-tetradecadiene, 7-methyl-1,6-octadiene, 9-methyl-1,8-decadiene, or mixtures thereof. Even more preferably, the diene is selected from 1,7-octadiene, 1,9-decadiene, 1,11-dodecadiene, 1,13-tetradecadiene, or any mixture thereof. In a preferred embodiment the LDPE is an LDPE homopolymer.

In one embodiment, the LDPE copolymer comprises 0.001 to 35 wt%, such as less than 30 wt%, for example less than 25 wt%, of one or more comonomer(s) relative to the total weight of the copolymer as a whole. Example ranges include 0.5 to 10 wt%, such as 0.5 to 5 wt% comonomer. Comonomer contents can be determined using FTIR.

The LDPE has a density of 905 to 935 kg/m³. In one embodiment the LDPE has a density greater than 905 kg/m³, such as at least 910 kg/m³. In one embodiment the LDPE has a density less than 935 kg/m³, such as 930 kg/m³ or less. In one embodiment, the LDPE has a density of 910 to 930 kg/m³.

The LDPE has an MFR₂ (2.16 kg, 190° C.) of 0.1 to 10 g/10 min. In one embodiment the LDPE has an MFR₂ of greater than 0.1 g/10 min, such as at least 0.2 g/10 min. In one embodiment the LDPE has an MFR₂ of less than 10 g/10 min, such as 5 g/10min or less. In one embodiment the LDPE has an MFR₂ of 0.2 to 5.0 g/10 min.

The LDPE of the present invention is not new. LDPE grades suitable for use according to the present invention may be obtained commercially.

### Component (ii) - High Density Polyethylene (HDPE)

Component (ii) of the polymer composition according to the present invention is a high density polyethylene (HDPE). Component (ii) forms 0.5 to 20% by weight of the overall polymer composition. In one embodiment, component (ii) forms 0.5 to 15 wt% of the polymer composition, preferably 1.0 to 8.0 wt%.

The HDPE may be a high density ethylene homopolymer (HDPE homopolymer) or a high density copolymer of ethylene and one or more comonomer(s) (HDPE copolymer). By ethylene copolymer is meant a polymer the majority by weight of which derives from ethylene monomer units. When the HDPE is an HDPE copolymer, the comonomer contribution preferably is up to 10% by mol, more preferably up to 5 % by mol, e.g.0.5 to 5.0 mol%.

In one embodiment the HDPE is an HDPE copolymer of ethylene and one or more comonomer(s). The other copolymerisable monomer or monomers are preferably selected from C₃₋₁₂, especially C₃₋₁₀, alpha-olefin comonomers, particularly singly or multiply ethylenically unsaturated comonomers, in particular C₃₋₁₀-alpha olefins such as propene, but-1-ene, hex-1-ene, oct-1-ene, and 4-methyl-pent-1-ene. The use of 1-hexene and 1-butene is particularly preferred.

In one embodiment the HDPE is an HDPE homopolymer.

The HDPE may be unimodal or multimodal. A polyethylene composition comprising at least two polyethylene fractions, which have been produced under different polymerisation conditions resulting in different (weight average) molecular weights and molecular weight distributions for the fractions, is referred to as “multimodal”. In a preferred embodiment, the HDPE is unimodal.

The HDPE may be made by any conventional process. In one embodiment, a polymerisation catalyst is used. Suitable polymerisation catalysts include coordination catalysts of a transition metal, such as Ziegler-Natta (ZN), metallocenes, non-metallocenes, Cr-catalysts etc. The catalyst may be supported, e.g. with conventional supports including silica, Al-containing supports and magnesium dichloride based supports. Preferably the catalyst is a ZN catalyst, more preferably the catalyst is a silica supported ZN catalyst.

The HDPE has a density of 940 kg/m³ or more. Preferably, the polymer has a density of 945 kg/m³ or more, still more preferably 950 kg/m³ or more. In one embodiment, the density of the polymer is 970 kg/m³ or lower, preferably is 965 kg/m³ or lower. In one embodiment the HDPE has a density of 940 to 970 kg/m³, preferably 945 to 965 kg/m³.

The HDPE has an MFR₂ (2.16 kg, 190° C.) of 0.1 to 50 g/10 min. In one embodiment, the HDPE has an MFR₂ of 1.0 to 20 g/10 min. In a preferred embodiment, the HDPE has an MFR₂ of at least 10 g/10 min, such as 10 to 20 g/10 min.

HDPE grades suitable for use according to the present invention may be obtained commercially.

### Component (iii) - Nanoparticle Filler

Component (iii) of the polymer composition according to the present invention is an aliphatic functional inorganic nanoparticle filler, preferably an alkyl functional inorganic nanoparticle filler. The term “aliphatic functional inorganic nanoparticle filler” as used herein refers to an inorganic nanoparticulate filler wherein the nanoparticles have been modified to incorporate one or more aliphatic functionalities at the surface of the nanoparticles. Such modifications are well known in the art and are discussed for example in WO2006/081400. In a preferred embodiment, the aliphatic functionality is an alkyl group, such that the nanoparticle filler is an alkyl functional inorganic nanoparticle filler.

The nanoparticles have a diameter of less than 1000 nm, preferably less than 500 nm, especially less than 250 nm. Nanoparticles preferably have a diameter of 10 nm or more, such as 25 nm or more. Nanoparticles preferably have a diameter of 10 to 100 nm, such as 25 to 75 nm. A diameter of 40 to 60 nm is most preferred. These diameters can be determined using TEM analysis.

Component (iii) forms 0.05 to 10% by weight of the overall polymer composition. In a preferred embodiment, the nanoparticle filler forms 0.5 to 10 wt%, preferably 1.0 to 8.0 wt% of the polymer composition.

In one embodiment, the nanoparticle filler comprises nanoparticles selected from inorganic oxides, hydroxides, carbonates, fullerenes, nitrides, carbides, kaolin clay, talc, borates, alumina, titania or titanates, silica, silicates, zirconia, zinc oxide, glass fibres or glass particles, or any mixtures thereof. In one embodiment, the nanoparticle filler comprises inorganic oxide nanoparticles, such as aluminium oxide, magnesium oxide, zinc oxide, silica, titanium oxide, iron oxide, barium oxide, calcium oxide, strontium oxide nanoparticles, or mixtures thereof.

In one embodiment the nanoparticle filler comprises MgO, SiO₂, TiO₂, ZnO, Al₂O₃, Fe₃O₄, barium oxide, calcium oxide, strontium oxide nanoparticles, or mixtures thereof. Preferably the nanoparticle filler comprises aluminium oxide, magnesium oxide, zinc oxide nanoparticles, or mixtures thereof. Most preferably the nanoparticle filler comprises aluminium oxide nanoparticles. In a preferred embodiment the nanoparticle filler comprises Al₂O₃, MgO, ZnO nanoparticles or mixture thereof, most preferably comprises Al₂O₃ nanoparticles.

The nanoparticles forming the nanoparticle filler according to the present invention are functionalised with aliphatic group(s) such as alkyl, alkenyl, cycloalkyl, alkylcycloalkyl groups. In a preferred embodiment, the aliphatic group(s) is an alkyl group(s), such that the nanoparticle filler is an alkyl functional inorganic nanoparticle filler. Said alkyl group(s) is preferably a C1-20 alkyl group, such as a C4-20 alkyl group, preferably C6 to C20 alkyl group. In a preferred embodiment, the alkyl group is a C6 to C12 alkyl group such as a C8 alkyl group.

The aliphatic group(s) may be linear or branched, preferably linear. In a preferred embodiment, the aliphatic group(s) is a linear alkyl group, such as a linear C1-20 alkyl group, especially a linear C4-20 alkyl group. In a preferred embodiment, the alkyl group is a linear C6-12 alkyl group, such as n-octyl.

The nanoparticles forming the nanoparticle filler may be functionalised by any known method. In one embodiment, the nanoparticle filler is functionalised by reaction with an aliphatic-functionalised silane, such as an alkylsilane. The aliphatic group on such a silane is the aliphatic group as described above for the functionalised nanoparticles. In a preferred embodiment, the nanoparticle filler is functionalised by reaction with an alkyl(trialkoxy)silane, dialkyl(dialkoxy)silane or trialkyl(alkoxy)silane, preferably an alkyl(trialkoxy)silane.

The alkyl part of the alkoxy group of the silane may be the same as the alkyl group of the silane or different. In a preferred embodiment, the alkoxy group is a C₁₋ ₁₀ alkoxy group, especially a linear C₁₋₁₀ alkoxy group, such as methoxy or ethoxy. For example, in one embodiment the nanoparticle filler is functionalised by reaction with an n-octyl(triethoxy)silane, n-octyl(trimethoxy)silane, di(n-octyl)(diethoxy)silane or di(n-octyl)(dimethoxy)silane.

The nanoparticle filler is typically in a solid powder form but can be carried in a medium, such as mineral spirits such as heptane, e.g. such that the mixture of the filler and the carrier forms a colloidal dispersion.

In one embodiment the aliphatic functional inorganic nanoparticle filler has a diameter of less than 1000 nm, preferably less than 500 nm, especially less than 250 nm. The aliphatic functional inorganic nanoparticle filler preferably has a diameter of 10 nm or more, such as 25 nm or more. The aliphatic functional inorganic nanoparticle filler preferably has a diameter of 10 to 100 nm, such as 25 to 75 nm. A diameter of 40 to 60 nm is most preferred.

The reaction between the nanoparticles of the nanoparticle filler and the aliphatic-functionalised silane may be conducted in solution. Suitable solvents are known to the person skilled in the art and include polar and non-polar solvents. In one embodiment, the reaction may be conducted in a solution comprising water, propanol, or mixtures thereof. A catalyst may be used in some embodiments to promote the hydrolysis and condensation of the silanes, for example ammonium hydroxide.

### Optional Further Components

Additionally, the polymer composition of the invention may contain, in addition to the components (i) to (iii), further component(s) such as polymer component(s) and/or additive(s), for example, additive(s), such as any of antioxidant(s), scorch retarder(s) (SR), crosslinking booster(s), stabiliser(s), processing aid(s), flame retardant additive(s), water tree retardant additive(s), acid or ion scavenger(s), nanoparticle filler(s) and voltage stabilizer(s), as known in the polymer field. The polymer composition may comprise, for example, conventionally used additive(s) for wire and cable (W&C) applications, such as one or more antioxidant(s) and optionally one or more of scorch retarder(s) or crosslinking booster(s), for example, at least one or more antioxidant(s). Suitable additives and amounts of additives are conventional and well known in the art.

### Process

In one aspect, the present invention provides a process for the preparation of the polymer composition as defined herein. The process comprises blending:
(i) at least 70 wt% of low-density polyethylene (LDPE) homopolymer or copolymer having a density of 905 to 935 kg/m³ and an MFR₂ of 0.1 to 10 g/10 min;
(ii) 0.5 to 20 wt% of a high density polyethylene (HDPE) having a density of 940 kg/m³ or more and an MFR₂ of 0.1 to 50 g/10 min; and
(iii) 0.05 to 10 wt% of an aliphatic, preferably alkyl, functional inorganic nanoparticle filler.

In one embodiment, the process comprises the further step of crosslinking the polymer composition. Crosslinking may be effected by any conventional means as well known in the art, such as peroxide crosslinking. Preferably the polymer composition is not crosslinked.

### Applications

The polymer composition according to the present invention can be used in any application area, but may particularly be suitable in the field of wire and cable (W&C) applications.

In one aspect the present invention provides a cable comprising the polymer composition according to the present invention. The cable according to the present invention comprises a conductor surrounded by one or more layers wherein one or more of said layers comprises the polymer composition as defined herein. In a further embodiment of the present invention, the cable is a power cable, for example a direct current (DC) power cable, comprising a conductor which is surrounded at least by an inner semiconductive layer, an insulation layer and an outer semiconductive layer, in that order, wherein at least one layer, for example at least the insulation layer, comprises or consists of the polymer composition as described herein. In one embodiment, the power cable is a high voltage (HV) power cable or an ultra-high voltage (UHV) power cable i.e. a cable capable of operating at voltages higher than 36 kV.

The present invention also provides the use of the polymer composition as described herein in the manufacture of a layer in a cable, such as the insulation layer, preferably a layer in a power cable e.g. the insulation layer of a power cable.

The cable according to the present invention may be prepared by any conventional means. In one embodiment, the cable is prepared by a process comprising the steps of:
(a) providing and mixing, preferably melt mixing in an extruder, the polymer composition as defined herein,
(b) applying a melt mix of the polymer composition obtained from step (a), preferably by (co)extrusion, on a conductor to form one or more layers, preferably at least an insulation layer, and
(c) optionally crosslinking at least the polymer composition in said at least one layer, preferably in the insulation layer.

### BRIEF DESCRIPTION OF THE FIGURES

FIG. 1 shows the conductivity of the samples disclosed in Table 1 as a function of temperature. The inventive examples comprising LDPE, HDPE and the nanoparticle filler have significantly lower conductivity than the comparative examples consisting of LDPE, LDPE+HDPE, or LDPE+nanoparticle filler alone.

FIG. 2 shows the storage modulus of the samples disclosed in Table 1 as a function of temperature. The inventive examples comprising LDPE, HDPE and the nanoparticle filler have significantly improved storage modulus than the comparative examples consisting of LDPE or LDPE + nanoparticle filler alone.

### DETERMINATION METHODS

Unless otherwise stated in the description or experimental part the following methods were used for the property determinations:

(wt% = % by weight)

### Density

The density of the polymer samples was measured according to ISO 1183-2.

### Melt Flow Rate (MFR)

The melt flow rate (MFR) is determined according to ISO 1133 and is indicated in g/10 min. The MFR is an indication of the flowability, and hence the processability, of the polymer. The higher the melt flow rate, the lower the viscosity of the polymer. Unless otherwise specified, the term MFR as used herein refers to MFR₂ (190° C., 2.16 kg).

### Sample Preparation

The polymer composition of the present invention and comparative examples, were melt compounded in a Micro 5 cc Twin Screw Compounder (DSM Xplore) at 150° C. for 6 min with a screw speed of 100 rpm. The extruded nanocomposite rods were cut into pellets and compression-moulded under a load of 200 kN into 80 µm thick films using a TP400 laboratory press (Fontijne Grotnes B.V., the Netherlands) at 130° C. for 10 min. The samples were finally cooled to 25° C. at a rate of 20° C./min while maintaining the compressive load.

### DC-conductivity Measurement

The electrical conductivity measurements were performed following standard procedure according to IEC, in Methods of Test for Volume Resistivity and Surface Resistivity of Solid Electrical Insulating Materials, Standard 60093, 1980, applying a direct current (DC) voltage (Glassman FJ60R2) over the film sample, i.e. the polymer composition of the present invention and comparative examples, and measuring the charging current with an electrometer (Keithley 6517A). The current signal was recorded by Lab VIEW software incorporated in a personal computer and stored for further analysis. An oven was used to control temperature, whereas an overvoltage protection secured the electrometer from damaging due to possible overshoots and a low-pass filter removed high frequency disturbances. A stainless steel three-electrode system was used, in which the high voltage electrode was a cylinder with a diameter of 45 mm, the current measuring electrode was 30 mm in diameter, and the guard ring eliminated surface currents. Good contact between the high-voltage electrode and the film sample was achieved by placing an Elastosil R570/70 (Wacker) layer between them. The experiments were conducted on at 60, 70 and 90° C. for 6 h. The applied voltage was 2.6 kV corresponding to an electric field of 30 kV/mm, giving conditions 60-(90° C.) in temperature and electric field resembling the stress conditions in the insulation of a real HVDC cable. The test was repeated twice for each material to assess the reproducibility.

### Storage Modulus (G′)

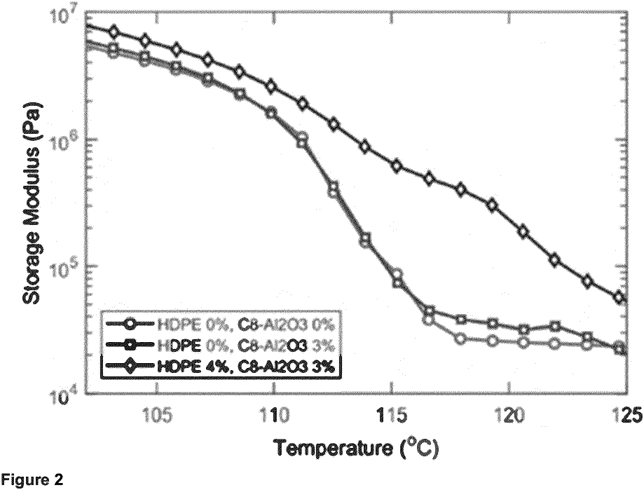

The storage modulus (G′) of the samples as a function of temperature was measured by dynamic mechanical thermal analysis (DMTA). The storage modulus is indicated in Pa. The characterisation of polymer melts by torsional dynamic mechanical thermal analysis (DMTA) was performed using an Anton Paar MCR702 TwinDrive (Graz, Austria) rheometer operating in the single motor-transducer configuration (stress-controlled). A SCF cylindrical sample fixture was used, with the temperature being controlled via a CTD450 convection oven. The temperature was increased from 30 to 130° C. at a rate of 2° C./min while the samples were subjected to a 1% strain amplitude at a frequency of 0.8 Hz. The test samples were prepared directly from extruded strands (3 mm in diameter) by cutting to a total length of 40 mm, so that the free sample length was ca. 26 mm. The results are shown in FIG. 2.

### Experimental Part

### Materials

The materials used in this work are as follows:
LDPE: Density 922 kg/m³, MFR₂ 1.9 g/10 min.
HDPE: (Unimodal Ziegler Natta HDPE, density = 962 kg/m³, MFR₂ at 190° C. = 12 g/10 min)
C₈—Al₂O₃: Preparation method described below

### Preparation of Octyl-Coated Aluminium-oxide Nanoparticles (C₈-Al₂O₃)

Aluminium oxide nanoparticles (Nanodur from Nanophase Inc, CAS number 1344-28-01, density 3.97 g/cm³) were coated with n-octyltriethoxysilane (Sigma-Aldrich, CAS-number 3069-42-9). The reactions were conducted in a mixed medium of 2-propanol and water. Ammonia hydroxide (aq. 25 %) was used as a catalyst to promote the hydrolysis and the condensation of the silanes. After surface modification, the nanoparticles were dried for 20 h at 80° C. in a vacuum oven (Fisher Scientific Vacucell, MMT group). The average diameter of the spherical Al₂O₃ nanoparticles was 50 nm, according to TEM images analysis.

### Preparation of Polymer Compositions

Octyl-coated aluminium oxide nanoparticles (C₈—Al₂O₃) were dispersed in n-heptane (0.3 ml n-heptane/1g nanoparticles) and ultrasonicated for 5 minutes, whereafter 0.02 wt.% antioxidant Irganox 1076 (Ciba Speciality Chemicals, CAS number 2082-79-3) was added. Desired proportions of grinded, low-density polyethylene LDPE and high density polyethylene HDPE were added to the nanoparticle suspensions.

The LDPE/HDPE/C₈—Al₂O₃ slurry was shaken for 1 h with a Vortex Genie 2 shaker (Scientific Instruments Inc) and dried overnight at 80° C. After drying, the powder was shaken for another 30 min and then extruded for 6 min at 150° C. and 100 rpm (Micro 5 cc twin screw compounder, Xplore instruments). The extruded materials were dried overnight at 80° C. in vacuum-oven.

### Results

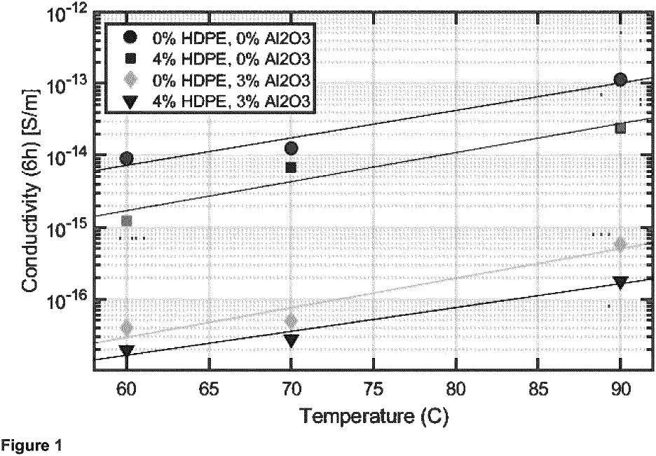

The composition and properties of samples of the polymer compositions according to the present invention (IE1-3) and samples of comparative compositions (CE1-9) are shown in Table 1. The DC-conductivity of each sample at each temperature is shown graphically in FIG. 1.

Table 1

| Example | LDPE (wt%) | HDPE (wt%) | C8—Al₂O₃ (wt%) | Temperature (°C) | Conductivity (S/m) |
|---|---|---|---|---|---|
| CE1 | 100 | | | 60 | 9.02E-15 |
| CE2 | 100 | | | 70 | 1.25E-14 |
| CE3 | 100 | | | 90 | 1.13E-13 |
| CE4 | 96 | 4 | | 60 | 1.24E-15 |
| CE5 | 96 | 4 | | 70 | 6.82E-15 |
| CE6 | 96 | 4 | | 90 | 2.36E-14 |
| CE7 | 97 | | 3 | 60 | 3.90E-17 |
| CE8 | 97 | | 3 | 70 | 4.86E-17 |
| CE9 | 97 | | 3 | 90 | 5.76E-16 |
| IE1 | 93 | 4 | 3 | 60 | 1.94E-17 |
| IE2 | 93 | 4 | 3 | 70 | 2.75E-17 |
| IE3 | 93 | 4 | 3 | 90 | 1.77E-16 |

The inventors have established that the inventive compositions have excellent (i.e. low) DC-conductivity, even at high temperatures (e.g. up to 90° C.). With reference to the data in Table 1 and FIG. 1, it can be seen that the DC-conductivity of the inventive compositions IE1-3 is unexpectedly more than two orders of magnitude lower than the pure LDPE compositions of CE1-3.

Surprisingly, the conductivity of the inventive examples is also significantly reduced relative to that of blends consisting of LDPE and HDPE (CE4-6) or LDPE and nanoparticle filler (CE7-9) alone. The reduction in DC conductivity may even be synergistic.

It is surprising that the conductivity of the polymer composition of the invention is so low given that the mechanism of conduction is different for the LDPE/HDPE blends and the LDPE/Al₂O₃ system. There is therefore no expectation that the conductivity of the combined polymer composition should be lower than the comparative examples.

Furthermore, this reduction in DC conductivity is obtained whilst maintaining or even improving the thermomechanical properties of the polymer composition (e.g. in terms of storage modulus). This is despite the presence of the nanoparticle filler which might be expected to reduce thermomechanical performance. The introduction of HDPE to LDPE creates a system that is melt miscible and phase separates upon crystallisation. This leads to the creation of co-crystals that create a network acting as physical crosslinks and gives the system far better thermomechanical properties. The introduction of the nanoparticles might be expected to disturb this fine balance but surprisingly this is not the case. Analysis of the blends suggests that the thermomechanical properties of the inventive examples are at least maintained or improved relative to the comparative examples (see FIG. 2).

The low conductivity of the compositions according the present invention makes them particularly suitable for use in applications where low conductivity is essential, such as in the insulation layer of power cables.

1. A polymer composition, comprising:
(i) at least 70 wt% of a low-density polyethylene (LDPE) homopolymer or copolymer having a density of 905 to 935 kg/m³ (ISO 1183-2) and an MFR₂ of 0.1 to 10 g/10 min (ISO1133 at 190° C., 2.16 kg);
(ii) 0.5 to 20 wt% of a high density polyethylene (HDPE) having a density of 940 kg/m³ or more and an MFR₂ of 0.1 to 50 g/10 min; and
(iii) 0.05 to 10 wt% of an aliphatic functional inorganic nanoparticle filler comprising inorganic nanoparticles each having a surface functionalized by an aliphatic group.

2. The polymer composition of claim 1, wherein the aliphatic functional inorganic nanoparticle filler comprises inorganic oxide nanoparticles.

3. The polymer composition of claim 1, wherein the aliphatic functional inorganic nanoparticle filler comprises aluminium oxide, magnesium oxide or zinc oxide nanoparticles.

4. The polymer composition of claim 1, wherein the aliphatic functional inorganic nanoparticle filler comprises aluminium oxide nanoparticles.

5. The polymer composition of claim 1, wherein the aliphatic group is a C1-20 alkyl group.

6. The polymer composition of claim 1, wherein the alkyl-aliphatic group is a C6-12 alkyl group.

7. The polymer composition of claim 1, wherein the aliphatic functional inorganic nanoparticle filler is functionalized by reaction with an alkylsilane .

8. The polymer composition of claim 1, wherein the LDPE is a low-density polyethylene homopolymer or an unsaturated LDPE copolymer of ethylene with at least one polyunsaturated comonomer .

9. The polymer composition of claim 1, wherein the polymer composition has a DC conductivity of:
less than 4.0 x10⁻¹⁷ S/m when measured at 70° C.;
less than 2.5 x10⁻¹⁷ S/m when measured at 60° C.;
less than 3.5 x10⁻¹⁶ S/m when measured at 90° C.;
or a combination thereof.

10. The polymer composition of claim 1, wherein the polymer composition is not crosslinked.

11. The polymer composition of claim 1, comprising
(i) at least 75 wt% of the low-density polyethylene (LDPE);
(ii) 0.5 to 15 wt% of the high density polyethylene (HDPE); and
(iii) 0.5 to 10 wt% of the aliphatic functional inorganic nanoparticle filler.

12. The polymer composition of claim 1, comprising
(i) at least 90 wt% of the low-density polyethylene (LDPE);
(ii) 1.0 to 8.0 wt% of the high density polyethylene (HDPE); and
(iii) 1.0 to 8.0 wt% of the aliphatic functional inorganic nanoparticle filler.

13. The polymer composition of claim 1, wherein the polymer composition has a storage modulus of:
at least 1.0x10⁵ Pa at 115° C.;
at least 5.0x10⁴ Pa at 120° C.;
at least 3.0x10⁴ Pa at 125° C.;
or a combination thereof.

14. A process for the preparation of the polymer composition of claim 1, the process comprising blending:
(i) at least 70 wt% of the low-density polyethylene (LDPE) homopolymer or copolymer ;
(ii) 0.5 to 20 wt% of the high density polyethylene (HDPE) ; and
(iii) 0.05 to 10 wt% of the aliphatic functional inorganic nanoparticle filler.

15. A cable comprising a conductor surrounded by one or more layers, wherein one or more of said layers comprises the polymer composition of claim 1 .

16. A power cable comprising a conductor surrounded at least by an inner semiconductive layer, an insulation layer, and an outer semiconductive layer, in that order, wherein at least one of the inner semiconductive layer, the insulation layer, or the outer semiconductive layer comprises the polymer composition of claim 1 .

17. The power cable of claim 16, wherein the power cable is a high voltage (HV) power cable or an ultra-high voltage (UHV) power cable.

18. A method of use of the polymer composition of claim 1, the method comprising using the polymer composition to manufacture of a layer in a cable.

19. The polymer composition of claim 1, wherein the aliphatic group comprises a linear C1-20 alkyl group.

20. The polymer composition of claim 8, wherein the polyunsaturated comonomer comprises a straight carbon chain with at least 8 carbon atoms, wherein at least 4 of the carbon atoms are between two non-conjugated double bonds, wherein at least one of the non-conjugated double bonds is terminal.
